(19) United States
(12) Patent Application Publication
(10) Pub. No.: US 2025/0076568 A1
(43) Pub. Date: Mar. 6, 2025

(54) PHOTONIC CRYSTAL FIBER

(71) Applicant: NIPPON TELEGRAPH AND TELEPHONE CORPORATION, Tokyo (JP)

(72) Inventors: Nobutomo HANZAWA, Musashino-shi, Tokyo (JP); Takayoshi MORI, Musashino-shi, Tokyo (JP); Takashi MATSUI, Musashino-shi, Tokyo (JP); Yoko YAMASHITA, Musashino-shi, Tokyo (JP); Kazuhide NAKAJIMA, Musashino-shi, Tokyo (JP)

(73) Assignee: NIPPON TELEGRAPH AND TELEPHONE CORPORATION, Tokyo (JP)

(21) Appl. No.: 18/293,918

(22) PCT Filed: Aug. 2, 2021
(86) PCT No.: PCT/JP2021/028662

§ 371 Date: Jan. 31, 2024

(51) Int. Cl. G02B 6/02

(52) U.S. Cl. CPC G02B 6/02323

(57) ABSTRACT

The present disclosure is a photonic crystal fiber in which a plurality of holes are formed in a cladding, having a uniform light refractive index, capable of propagating three modes of a fundamental mode, a first higher-order mode, and a second higher-order mode, wherein the plurality of holes are disposed in a triangular lattice pattern so as to surround a center of the photonic crystal fiber with no hole disposed at the center of the photonic crystal fiber, and the photonic crystal fiber has a ratio d/A of a diameter d of each of the holes to a pitch A between the holes such that a confinement loss of a third higher-order mode at a minimum wavelength within a used wavelength range is 1.0 dB/m or more and a confinement loss at a maximum wavelength is 0.001 dB/km or less.

### TECHNICAL FIELD

The present disclosure relates to a photonic crystal fiber.

### BACKGROUND ART

In recent years, transmitting power using an optical fiber has been attracting attention. In order to transmit high-power light over a long distance using an optical fiber, it is necessary to suppress stimulated Raman scattering (SRS), which is a nonlinear phenomenon, and to suppress a phenomenon called fiber fuse, and it has been shown that a photonic crystal fiber (PCF) effectively suppresses both phenomena [e.g., refer to Non Patent Literatures 1 and 2.].

In order to achieve good transmission characteristics for communication, a single-mode PCF having low nonlinearity has been proposed so far [e.g., refer to Non Patent Literature 1.]. In addition, it is necessary to suppress the SRS also for laser processing, and it has been reported that effective single-mode operation can be achieved by a structure in which the number of holes in the innermost side of the PCF is increased with a third higher-order mode, having a peak of intensity at a core center part, set as a cutoff in order to greatly increase an effective cross-sectional area [e.g., refer to Non Patent Literature 3.].

The PCF disclosed in Non Patent Literature 1, which has different hole diameters between the innermost side and the outer side, has a problem that it is difficult to keep the hole structure during manufacture of the fiber. On the other hand, the structure disclosed in Non Patent Literature 3, in which hole diameters are constant in the cross-section, has a problem that there are a large number of holes requiring processing time thereof in manufacture of a base material.

### CITATION LIST

### Non Patent Literature

Non Patent Literature 1: T. Matsui et al., “Single-mode Photonic crystal fiber design with ultralarge effective area and low bending loss ultrahigh-speed WDM transmission,” J. Lightwave Technol., vol. 29, no. 4, 2011.
Non Patent Literature 2: N. Hanzawa et al., “Suppression of fiber fuse propagation in hole assisted fiber and photonic crystal fiber,” J. Lightwave Technol., vol. 28, no. 15, 2010.
Non Patent Literature 3: T. Matsui et al., “Effective area Enlarged photonic crystal fiber with quasi-uniform air-hole structure for high power transmission,” IEICE Trans. Commun., vol. E103-B, no. 4, 2020.

### SUMMARY OF INVENTION

### Technical Problem

An object of the present disclosure is to make it realizable to provide a PCF capable of propagating high input light over several kilometers, with a structure that is relatively easy to manufacture.

### Solution to Problem

In a photonic crystal fiber of the present disclosure, a third higher-order mode, having a peak intensity at the center of a core, is set as a cutoff, and a confinement loss at a maximum wavelength to be used is set within a range that does not greatly affect transmission over 10 km, so that high-power light can be transmitted over a long distance even with the number of holes being 36 or less.

Specifically, a photonic crystal fiber of the present disclosure is
a photonic crystal fiber in which a plurality of holes are formed in a cladding, having a uniform light refractive index, capable of propagating three modes of a fundamental mode, a first higher-order mode, and a second higher-order mode, wherein
the plurality of holes are disposed in a triangular lattice pattern so as to surround a center of the photonic crystal fiber with no hole disposed at the center of the photonic crystal fiber, and
the photonic crystal fiber has a uniform ratio d/A of a diameter d of each of the holes to a pitch A between the holes such that a confinement loss of a third higher-order mode at a minimum wavelength within a used wavelength range is 1.0 dB/m or more and a confinement loss at a maximum wavelength is 0.001 dB/km or less.

### Advantageous Effects of Invention

The present disclosure can realize provision of a PCF capable of propagating high input light over several kilometers, with a structure that is relatively easy to manufacture.

### BRIEF DESCRIPTION OF DRAWINGS

FIG. 1 is a configuration example of a three-layer PCF.

FIG. 2A is a structure example of the three-layer PCF.

FIG. 2B is a structure example of the three-layer PCF.

FIG. 3 is an example of A_{eff} with respect to A and d/A.

FIG. 4 is a configuration example of a two-layer PCF.

FIG. 5A is a structure example of the two-layer PCF.

FIG. 5B is a structure example of the two-layer PCF.

### DESCRIPTION OF EMBODIMENTS

The following describes embodiments of the present disclosure in detail with reference to the drawings. Note that the present disclosure is not limited to the embodiments described below. These embodiments are merely examples, and the present disclosure can be carried out in forms with various modifications and improvements based on the knowledge of those skilled in the art. In addition, constituents having the same reference signs in the present description and the drawings indicate the same constituents.

A photonic crystal fiber of the present disclosure is a photonic crystal fiber having a 1-cell structure in which a plurality of holes are formed in a cladding having a uniform light refractive index capable of propagating three modes of a fundamental mode, a first higher-order mode, and a second higher-order mode. In the photonic crystal fiber, a confinement loss of a third higher-order mode at a minimum wavelength within a used wavelength range is 1.0 dB/m or more. Here, the 1-cell structure refers to a structure in which only a center part of the fiber is filled with a glass material as a core instead of one hole. The present disclosure enables usage of a region with a large d/A by setting the third higher-order mode as a cutoff, thereby enabling satisfaction of specified values of a bending loss and a confinement loss even with the number of holes being 36 or less.

Regarding the 1-cell structure in which a plurality of holes are disposed in a triangular lattice pattern, the present disclosure proposes a structure that satisfies the specified values of the bending loss and the confinement loss even when the number of holes is 36, and also proposes a structure that satisfies the specified values of the bending loss and the confinement loss even when the number of holes is 18. The present disclosure shows two examples: an example in which the used wavelength range is between 1530 nm and 1625 nm inclusive and an example in which the used wavelength range is between 1460 nm and 1625 nm inclusive.

### Embodiment 1

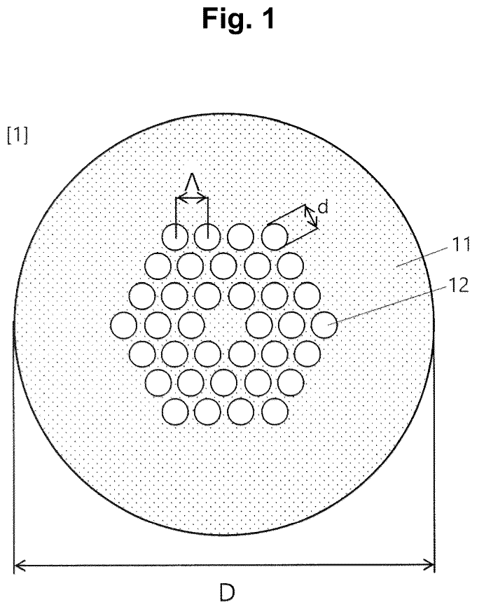

The present embodiment relates to a structure of a PCF with a three-layer structure having 36 holes. FIG. 1 is a drawing illustrating a cross-sectional structure of the three-layer PCF of the present embodiment. As illustrated in FIG. 1, the three-layer PCF has the 1-cell structure, including a core part and a cladding part 11 surrounding the core part, in which the core part and the cladding part 11 are made of a medium having a uniform light refractive index, and 36 uniform holes 12 are formed in the cladding part 11 along a longitudinal direction.

In the present disclosure, structural parameters will be described below with a diameter of the cladding 11 defined as D [μm], a hole diameter defined as d [μm], and a hole pitch defined as A [μm]. A method for selecting the structural parameters with which the bending loss and the confinement loss satisfy the specified values, with the third higher-order mode set as the cutoff, will be subsequently described.

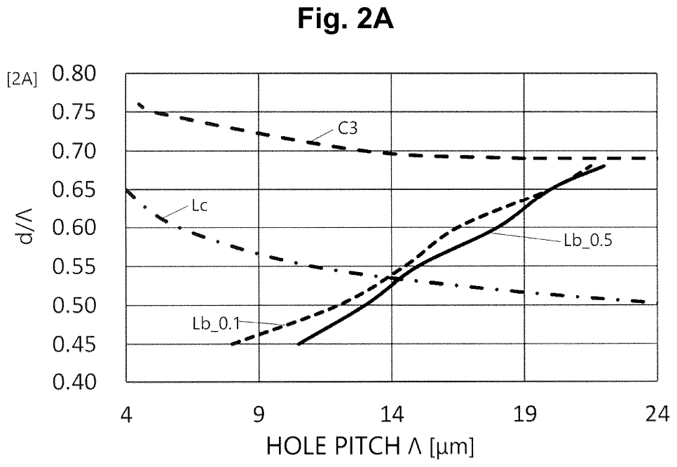

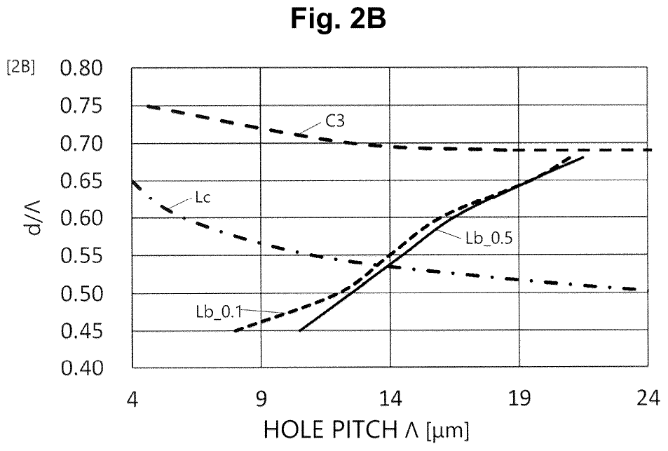

FIG. 2A illustrates an example of boundary conditions of the bending loss and the confinement loss where the used wavelength range is between 1530 nm and 1625 nm inclusive with the horizontal axis defined as λ and the vertical axis defined as d/λ. A curve Lb_0.5 indicated by a solid line represents a boundary at which the bending loss at a bending radius of 30 mm at a wavelength of 1530 nm is 0.5 dB/100 turns or less. Lc indicated by an alternate long and short dash line represents a boundary at which the confinement loss at a wavelength of 1625 nm is 0.001 dB/km or less. C3 indicated by a dashed line represents a boundary at which the confinement loss of the third higher-order mode at a wavelength of 1530 nm is 1 dB/m or more.

A region surrounded by the three curves Lb_0.5, Lc, and C3 indicates a structure satisfying the specified values. For example, given that λ is 19 μm, the specified values of the bending loss and the confinement loss can be satisfied by setting d/λ to 0.65. As can be seen from FIG. 2A, the structure has d/λ within a range of 0.52 to 0.76 and λ within a range of 9 μm to 22 μm.

The specified value of the bending loss of a typical single-mode optical fiber as described in ITU-TG.652D is 0.1 dB/100 turns or less with a radius set to 30 mm, and is represented by a curve Lb_0.1 indicated by a dotted line in FIG. 2A. The curve is close to the curve Lb_0.5 of 0.5 dB/100 turns, and the hole pitch A needs reducing slightly. It is preferable to use a required bending loss specified value for adjusting to the intended use.

FIG. 2B is a drawing illustrating a structure similar to that of FIG. 2A, and is a calculation result where the cutoff wavelength of the third higher-order mode and the wavelength defining the bending loss are 1460 nm. The structure in FIG. 2A, FIG. 2B, or the like is selected for adjusting to a wavelength band to be used. As can be seen from FIG. 2B, the structure has d/λ within a range of 0.54 to 0.75 and λ within a range of 9 μm to 22 μm.

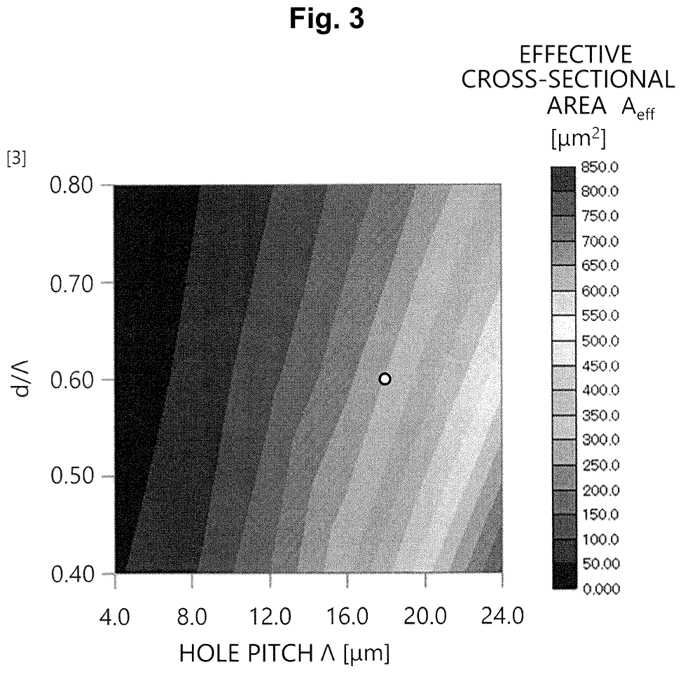

FIG. 3 is a drawing illustrating a value of an effective cross-sectional area A_{eff} at a wavelength of 1530 nm in the structure with the horizontal axis as λ and the vertical axis as d/λ. When a structure maximizing the A_{eff} is selected from the structures satisfying the values specified from FIG. 2A with the diameter D of the cladding 11 set to, for example, 125 μm, then λ=18 μm, d/λ=0.60, and the A_{eff} thereat is about 300 μm².

Assuming that a transmission loss is 0.2 dB/km from this structure, a threshold Pₜₕ of SRS in transmission over 10 km is 9.88 W according to Formula (1). Therefore, the PCF of the present embodiment enables light input of about 10 W.

$$( Math . 1 )$$

$${P}_{th} = 16 {A}_{eff} / {g}_{R} {L}_{eff} \qquad ( 1 )$$

Here, g_{R} is a Raman gain coefficient. As shown in Formula (2) described in Non Patent Literature 4, g_{R} depends on a dopant added to the core part of the optical fiber.

$$( Math . 2 )$$

$${g}_{R} = 0.94 \times 1 {0}^{- 11} ( 1 + 80 \times Δ ) / λ \qquad ( 2 )$$

In addition, L_{eff} is an interaction length and is expressed by Formula (3).

$${L}_{eff} = \{ 1 exp ( - α \times L ) \} / α \qquad ( 3 )$$

In Formulas (2) and (3), A represents a relative refractive index difference between the core and the cladding of the optical fiber, and is 0 in a pure quartz PCF. A represents a wavelength input to the optical fiber, a represents a transmission loss at the wavelength, and L represents a fiber length.

### Embodiment 2

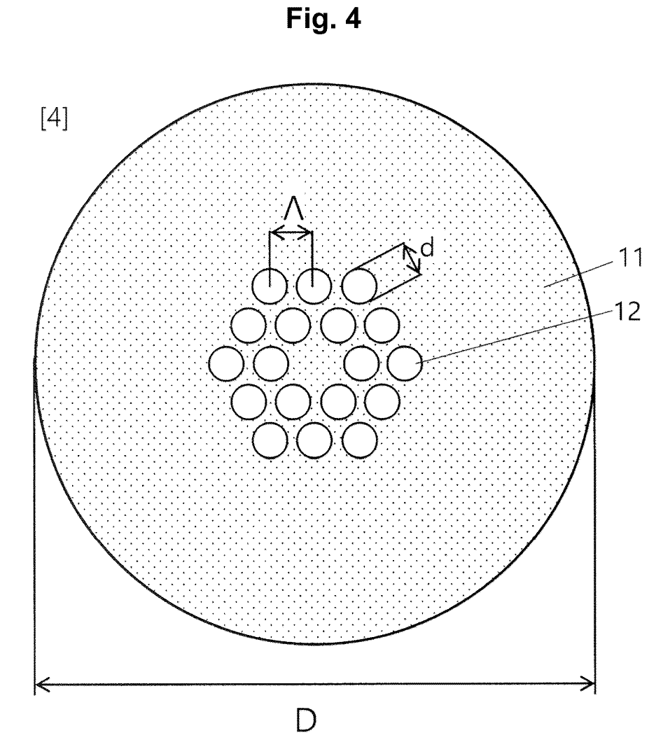

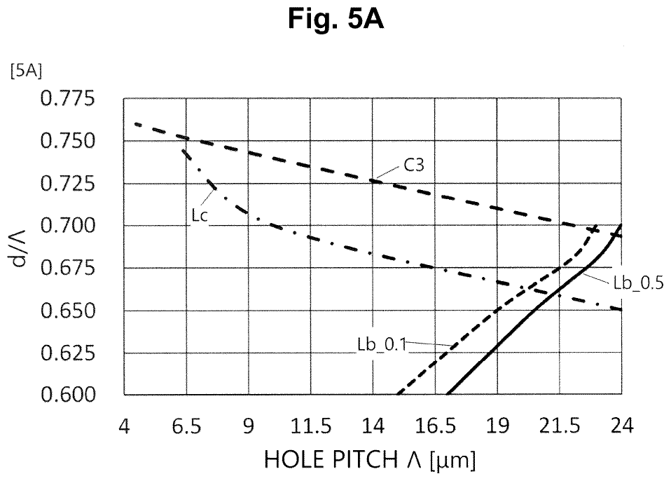

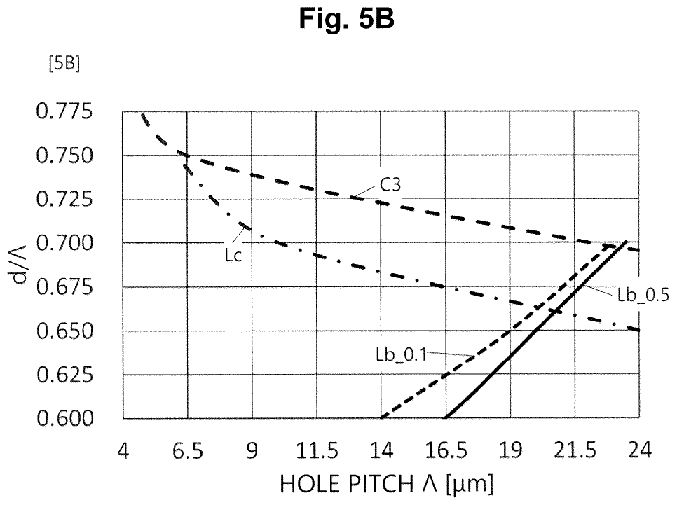

The present embodiment relates to a structure of a PCF with a two-layer structure having 18 holes. FIG. 4 is a drawing illustrating a cross-sectional structure of the two-layer PCF of the present embodiment. Since the PCF with the two-layer structure has substantially the same value of A_{eff} resulted from A and d/λ, the value of A_{eff} refers to the value in FIG. 3. FIG. 5A illustrates boundaries of the two-layer structure at which bending losses Lb_0.5 and Lb_0.1 at a wavelength of 1530 nm, a confinement loss Lc at a wavelength of 1625 nm, and a confinement loss C3 of the third higher-order mode at a wavelength of 1530 nm satisfy the specified values similarly to Embodiment 1. As can be seen from FIG. 5A, the structure approximately has d/λ within a range of 0.66 to 0.75 and λ within a range of 6.5 μm to 22 μm.

Similarly to Embodiment 1, FIG. 5B illustrates a result of calculating the cutoff of the third higher-order mode and the bending loss at a wavelength of 1460 nm, and it is preferable to select the structure based on a wavelength band to be used and a required bending loss. As can be seen from FIG. 5B, the structure has d/λ within a range of 0.65 to 0.75 and λ within a range of 6.5 μm to 22 μm.

When a structure maximizing the A_{eff} is selected from the structures of FIGS. 5A and 5B with a cladding diameter of 125 μm, then λ=20 μm, d/λ=0.68, and the A_{eff} thereat is about 320 μm². Assuming that a transmission loss is 0.2 dB/km from this structure, a threshold Pₜₕ of SRS in transmission over 10 km is 10.5 W according to Formula (1). Therefore, the PCF of the present embodiment enables light input exceeding 10 W.

In the present embodiments, on condition of 10.0≤λ≤18.0 and 0.56≤d/λ≤0.72 in FIGS. 2A and 2B, the cladding diameter is within 125 μm even in the three-layer structure. Therefore, it is possible to produce the optical fiber by using drawing equipment for an optical fiber with a typical coating diameter or the like, and to provide the optical fiber capable of propagating high input light, together with ensuring compatibility with existing optical fiber components such as a connector assembly.

In addition, in FIGS. 2B and 5B in which the cutoff wavelength is set to 1460 nm, the cladding diameter is within 125 μm in the three-layer structure on condition of 8.0≤λ≤18.0 and 0.58<d/λ≤0.72 illustrated in FIG. 2B, and the cladding diameter is within 125 μm in the two-layer structure on condition of 10.0≤λ≤22.5 and 0.67≤d/λ≤0.73 illustrated in FIG. 5B. In these examples, it is possible to flexibly use a wavelength for power supply and a wavelength of signal light by using existing equipment and components.

For example, by setting the signal light to 1490 nm and setting a power supply light to 1550 nm, it is possible to generate a signal by a device such as an existing small form factor pluggable (SFP) device, and to use, for the power supply light, a C-band that is a low-loss band of an optical fiber and in which a high-output amplifier and a high-output laser are provided. A communication light may be set to a 1550-nm band or a 1600-nm band, and the power supply light may be set to 1480 nm. The combination of the communication light and the power supply light can be changed, depending on a system.

Furthermore, in the present embodiments, on condition of 18.0≤λ≤21.5 and 0.62≤d/λ≤0.69 illustrated in FIGS. 2A and 2B, and on condition of 18.0≤λ≤22.5 and 0.67≤d/λ≤0.72 illustrated in FIGS. 5A and 5B, the effective cross-sectional area A_{eff} is 300 μm² or more. Therefore, in consideration of the SRS threshold, optical power of 10 W or more can be input even with a fiber length of 10 km. Considering that the transmission loss of 0.2 dB/km can be achieved in the PCF, optical power of about 6 W can be obtained at an output end. Considering that the current conversion efficiency of a power feeding converter is about 30%, and electric power of about 2 W can be obtained.

### Effects of Present Disclosure

As described above, according to the present disclosure, it is realizable to provide a PCF capable of propagating high input light over several kilometers by greatly increasing the effective cross-sectional area, with the structure having 36 holes at most, which is relatively easy to manufacture.

### INDUSTRIAL APPLICABILITY

The present disclosure can be applied to information and communication industries.

### REFERENCE SIGNS LIST

11 cladding
12 hole

1. A photonic crystal fiber in which a plurality of holes are formed in a cladding, having a uniform light refractive index, capable of propagating three modes of a fundamental mode, a first higher-order mode, and a second higher-order mode, wherein
the plurality of holes are disposed in a triangular lattice pattern so as to surround a center of the photonic crystal fiber with no hole disposed at the center of the photonic crystal fiber, and
the photonic crystal fiber has a uniform ratio d/λ of a diameter d of each of the holes to a pitch ∧ between the holes such that a confinement loss of a third higher-order mode at a minimum wavelength within a used wavelength range is 1.0 dB/m or more and a confinement loss at a maximum wavelength is 0.001 dB/km or less.

2. The photonic crystal fiber according to claim 1, wherein
the number of holes of the plurality of holes is 36,
the plurality of holes are three layers of holes surrounding the center of the photonic crystal fiber,
the d/∧ is between 0.62 and 0.69 inclusive, and
the ∧ is between 18.0 and 21.5 inclusive.

3. The photonic crystal fiber according to claim 1, wherein
the number of holes of the plurality of holes is 36,
the plurality of holes are three layers of holes surrounding the center of the photonic crystal fiber,
the d/∧ is between 0.58 and 0.72 inclusive, and
the ∧ is between 8.0 and 18.0 inclusive.

4. The photonic crystal fiber according to claim 1, wherein
the number of holes of the plurality of holes is 18,
the plurality of holes are two layers of holes surrounding the center of the photonic crystal fiber,
the d/∧ is between 0.67 and 0.72 inclusive, and
the ∧ is between 18.0 and 22.5 inclusive.

5. The photonic crystal fiber according to claim 1, wherein
the number of holes of the plurality of holes is 18,
the plurality of holes are two layers of holes surrounding the center of the photonic crystal fiber,
the d/∧ is between 0.67 and 0.73 inclusive, and
the ∧ is between 10.0 and 22.5 inclusive.

6. The photonic crystal fiber according to claim 1, wherein
the photonic crystal fiber has the d/∧ such that a bending loss at the minimum wavelength within the used wavelength range is 0.5 dB/100 turns or less at a bending radius of 30 mm.
